(19) United States
(12) Patent Application Publication
(10) Pub. No.: US 2006/0262541 A1
(43) Pub. Date: Nov. 23, 2006

(54) Contrast enhancement on a domelight

(75) Inventors: Rene Goulet, Ancienne-Lorette (CA); Martin Beaumont, Sainte-Foy (CA); Claude Sylvain, Quebec City (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: GE Security, Inc.

(21) Appl. No.: 11/134,337

(22) Filed: May 23, 2005

(51) Int. Cl. F21V 15/00; B60Q 3/04

(52) U.S. Cl. 362/362

(57) ABSTRACT

A domelight which includes a housing body defining at least one light-emitting surface for transmission of light by an LED. The housing body includes at least one contrast surface adjacent the at least one light-emitting surface. The at least one contrast surface includes a first contrast surface disposed on a first side of the at least one light-emitting surface and a second contrast surface disposed on a second side of the at least one light-emitting surface opposite the first side. The housing body further defines a plurality of light-emitting surfaces for transmission of light by a plurality of LEDs. The plurality of light-emitting surfaces are arranged substantially parallel to each other and spaced apart by a contrast surface disposed between each of the plurality of light-emitting surfaces.

### FIELD OF THE INVENTION

The present invention relates generally to electronics and semiconductors. More particularly, the present invention relates to an apparatus and method for enhancing the visibility and perception of a light-emitting diode device.

### BACKGROUND OF THE INVENTION

This invention relates to “domelights,” which are small lights used to provide a visual signal or indicator, housed in a dome-like housing, shell or similar structure. The domelight may have one or more light-emitting elements, and may have any shape, although since the lights are commonly attached to planar surfaces, they may have a dome-like shape for practical purposes. Domelights may also include one or more of a number of differing light-emitting elements. One common such element is a light-emitting diode. A light emitting diode, or “LED,” is well-known in the field of electronics. Unlike ordinary incandescent bulbs, they do not have a filament but are illuminated solely by the movement of electrons in a semiconductor material. As such, they are good choices for use in a domelight, due to their comparatively low consumption of energy, low heat losses, long life, and consistency. A domelight may include more than one LED, while the color of light emitted by the LED may also vary according to the needs associated with the particular domelight.

In a hospital environment, systems utilize domelights to signal to a nurse or doctor or other staff member regarding a particular call or patient condition. The domelight is generally placed in a corridor or hallway and must be viewed from a long distance and a range of viewing angles. The domelights also have multiple light-emitting elements which have different colors. Each color indicates a particular call or condition as a signal to the hospital staff.

Because of the hectic pace and high traffic through a hospital corridor, it is often difficult to notice or become aware of a domelight, or a change in the color or condition of a domelight. Increasing the size of the domelight is generally not a good solution, for both economic and space-saving reasons. Increasing the luminance or brightness of the domelight is one solution, but this demands more energy and comes at a higher cost.

Accordingly, it is desirable to provide a method and apparatus that increases the visibility and noticeability of a domelight, without consuming additional energy or generating significant added costs.

### SUMMARY OF THE INVENTION

The foregoing needs are met, to a great extent, by the present invention, wherein in one aspect an apparatus is provided that in one or more embodiments increases the visibility and noticeability of a domelight, without consuming additional energy or generating significant added costs.

In accordance with one embodiment of the present invention, a domelight for an LED device is provided. The domelight includes a housing body defining at least one light-emitting surface for transmission of light by an LED. The housing body includes at least one contrast surface adjacent the at least one light-emitting surface. The at least one contrast surface includes a first contrast surface disposed on a first side of the at least one light-emitting surface and a second contrast surface disposed on a second side of the at least one light-emitting surface opposite the first side. The housing body further defines a plurality of light-emitting surfaces for transmission of light by a plurality of LEDs. The plurality of light-emitting surfaces are arranged substantially parallel to each other and spaced apart by a contrast surface disposed between each of the plurality of light-emitting surfaces.

In accordance with another aspect of the present invention, a domelight includes a housing body having at least one LED. The at least one LED includes a lens body and at least one light-emitting surface on the lens body for transmission of light by the LED. The housing body also includes at least one contrast surface adjacent the at least one light-emitting surface. The at least one light-emitting surface has a first width and the at least one contrast surface has a width at least as great as the first width. Each width is defined in a direction spanning at least both of the at least one light-emitting surface and the at least one contrast surface.

In accordance with yet another aspect of the present invention, a domelight for an LED device is provided, having an assembly for transmitting light from an LED through at least one light-emitting surface, and a surface treatment on a portion of the assembly for surrounding the at least one light-emitting surface with a contrast surface. The at least one contrast surface includes a first contrast surface disposed on a first side of the at least one light-emitting surface and a second contrast surface disposed on a second side of the at least one light-emitting surface opposite the first side. The assembly includes a plurality of LEDs, each LED having a lens body with a light-emitting surface. The light-emitting surfaces are arranged substantially parallel to each other and spaced apart by a contrast surface disposed between the light-emitting surfaces. The at least one light-emitting surface has a first width and the at least one contrast surface has a width at least as great as the first width. Each width is defined in a direction spanning at least both of the at least one light-emitting surface and the at least one contrast surface.

In still another aspect of the present invention, a method of displaying light emitted by an LED device is provided. Light is emitted from at least one LED through at least one light-emitting surface. And a contrast surface is disposed adjacent to the at least one light-emitting surface. The at least one contrast surface includes a first contrast surface disposed on a first side of the at least one light-emitting surface. A second contrast surface is disposed on a second side of the at least one light-emitting surface opposite the first side. The at least one LED includes a plurality of LEDs. Each LED includes a lens body with a light-emitting surface. The light-emitting surfaces are arranged substantially parallel to each other and spaced apart by a contrast surface disposed between the light-emitting surfaces.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective exploded view of a domelight assembly incorporating one embodiment of the invention.

FIG. 2 is an assembled view of the domelight of FIG. 1, without any contrast enhancement elements of the present invention.

FIG. 3 is a view of the domelight assembly shown in FIG. 2, with contrast enhancement elements arranged in accordance with one embodiment of the present invention.

### DETAILED DESCRIPTION

The invention will now be described with reference to the drawing figures, in which like reference numerals refer to like parts throughout. An embodiment in accordance with the present invention provides a domelight which includes a housing body defining at least one light-emitting surface for transmission of light by an LED. The housing body includes at least one contrast surface adjacent the at least one light-emitting surface. The at least one contrast surface includes a first contrast surface disposed on a first side of the at least one light-emitting surface and a second contrast surface disposed on a second side of the at least one light-emitting surface opposite the first side. The housing body further defines a plurality of light-emitting surfaces for transmission of light by a plurality of LEDs. The plurality of light-emitting surfaces are arranged substantially parallel to each other and spaced apart by a contrast surface disposed between each of the plurality of light-emitting surfaces.

As used herein, the term “contrast surface” shall mean an area on a body, the area having a color, tone, brightness, or luminous intensity that is significantly different than a space directly adjacent to the area. The difference in color, tone, brightness, or luminous intensity is generally along the darker or duller end of the spectrum for each property, as the case may be. Also as used herein, the term “surface” shall mean the surface of any body, or any plane or complex surface in space, defined by a body, its elements, or the edges on said body or elements.

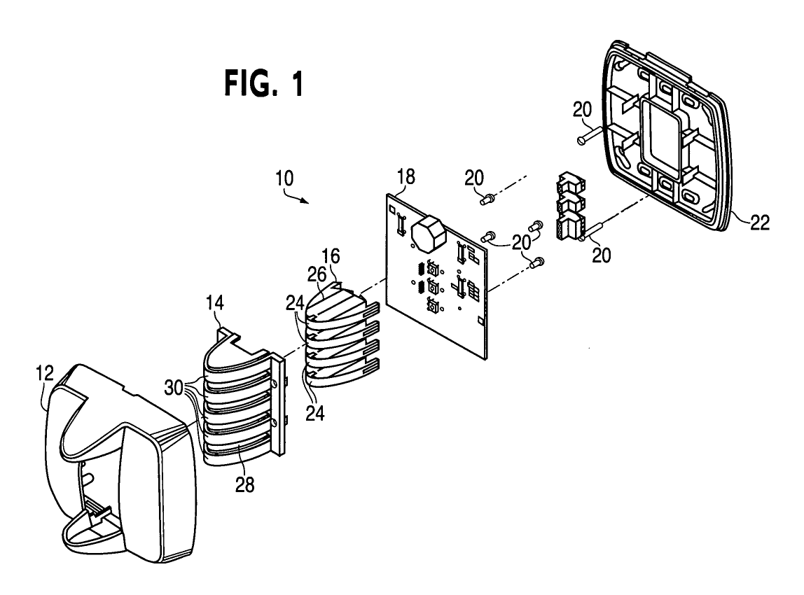

An embodiment of the present inventive apparatus is illustrated in FIG. 1. FIG. 1 shows a perspective exploded view of a domelight assembly 10 arranged according to one embodiment of the invention. Assembly 10 includes a housing body 12, a lens holder 14, a set of four LED lenses or lens bodies 16, a circuit board 18, a set of fasteners 20, and a base or frame 22. Each lens body 16 includes a light-emitting surface 24. The light-emitting surface extends in an arcuate shape between two substantially parallel sidewalls 26 of each lens body 16.

In the embodiment shown in FIG. 1, the lens bodies 16 are arranged parallel to each other such that they fit into corresponding recesses 28 defined by the lens holder 14 as shown. The recesses 28 are arcuate surfaces which receive the light-emitting surfaces 24 on the lens bodies 16 and are substantially the same in shape to the light-emitting surfaces 24 on the lens bodies 16. Circuit board 18 is a PCB assembly which includes the several LEDs that are mounted flush against the base portions of lens bodies 24. It is understood therefore, that light-emitting surfaces 24 are also light-transmitting surfaces, receiving light focused and directed from the LED elements on circuit board 18. As used herein, the term “light-emitting” as applied to a surface shall also mean light-transmitting or light-diffusing, as may be applicable, and as is generally applied to any area that is readily perceived to generate or give off light that is visible.

In order to increase the visibility of the light emitted by the LEDs through lenses 16, a number of contrast surfaces 30 are provided on the lens holder 14. As shown in FIG. 1, contrast surfaces 30 are darkened areas that are adjacent to the light-emitting surfaces 24. It is understood that the contrast surfaces 30 may constitute a portion or portions of the actual surface of the lens holder 14 itself, or may be a layer or set of layers deposited or disposed on the lens holder 14. The contrast surfaces 30 may have a wide range of brightness, tone, color, or luminance values. For the present invention, each contrast surface 30 must have a brightness, tone, color, or luminance that is significantly different from the corresponding value of the light-emitting surface 24 adjacent to the contrast surface 30, when such light-emitting surface 24 is actually emitting light. Generally, this means that the contrast surface is a dark region, having a very low brightness or luminance, given the comparatively high brightness and luminance of light emitted by the LEDs transmitting light through the light-emitting surfaces 24.

The contrast of an optical imaging system is given by the formula: C=(Iₘₐₓ−Iₘᵢₙ)/(Iₘₐₓ+Iₘᵢₙ), where C is the contrast value, Iₘₐₓ is the maximum luminance or intensity of light coming from the lighted section, and Iₘᵢₙ is the minimum luminance or intensity of light coming from the darker section. Thus, for the present invention, Iₘₐₓ would be the value assigned to the intensity of light emanating from the light-emitting surfaces 24 on the lens bodies 16. And Iₘᵢₙ would be the value assigned to the intensity of light emanating from the contrast surfaces 30. Therefore, to obtain the highest level of contrast, it would be desirable to have Iₘᵢₙ assume the lowest value or setting possible, for a given luminance of light emitted by the LED device, set by Iₘₐₓ.

The contrast surface may therefore be black, or substantially dark and colorless. It may also be shaded in some darker shade, or have any variety of patterns or designs that have a relatively low brightness, reflectivity or luminous intensity. By creating a contrast between the light-emitting surfaces 24 and contrast surfaces 30 the light emitted by the domelight assembly 12 will be more noticeable to the observer and therefore more easily visible from a distance and from a range of viewing angles.

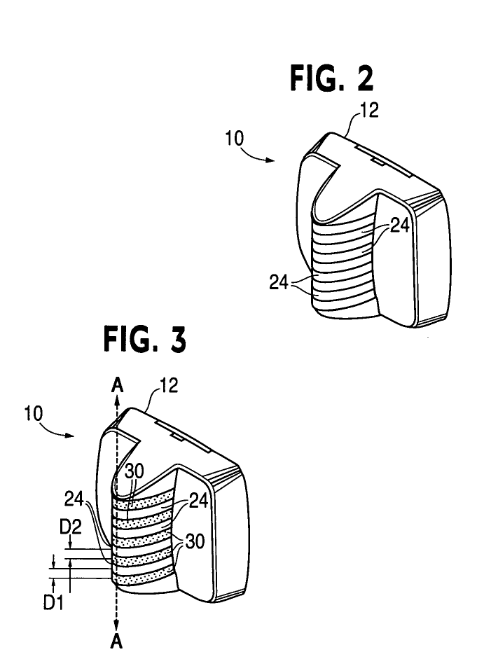

FIG. 2 is an assembled view of the domelight of FIG. 1, without any contrast enhancement elements 30 of the present invention. As can be seen in FIG. 2, if the areas or surfaces adjacent the light-emitting surfaces 24 are of comparable brightness, tone, color or luminous intensity as the light-emitting surfaces 24, there will be little contrast and this will detract from the function of the domelight 10, which is to provide a visual indicator that is quickly and accurately noticed from afar. The various light-emitting surfaces 24 may also be arranged to emit light of varying colors. In this case, the light emitted from the different colored LED elements will blend into each other and there will be poor contrast and separation between the colors.

FIG. 3 is a view of the domelight assembly shown in FIG. 2, with contrast enhancement elements 30 arranged in accordance with one embodiment of the present invention. As can be seen in FIG. 3, the contrast surfaces 30 provide a dark separation or buffer between the light-emitting surfaces 24, such that light emitted by the light-emitting surfaces 24 does not mix or blend easily. In addition to providing contrast, the present invention also enhances the separation and distinct viewing of different LED elements on a device, further increasing its visibility and noticeability. This is particularly advantageous in a hospital environment, where visibility and noticeability are desired for domelights that are programmed or arranged to emit a variety of signals or colors of light.

Another feature of the present invention involves the spacing of the width of the light-emitting surfaces 24 and contrast surfaces 30. By width, it is understood that the dimension of width is measured along axis A as shown, being defined in a direction spanning, crossing, or encompassing at least one of a light-emitting surface 24 and at least one of a contrast surface 30. To provide better contrast and visual noticeability, the width D1 of a contrast surface 30 can be at least as great as the width D2 of the light-emitting surface 24. This is the case for the embodiment shown in FIG. 3, and may be preferred for practical purposes in a hospital environment. D1 can also be greater than D2. In the extreme example, D1>>D2, such as when a large contrast surface or field surrounds a small point of light. This will provide an extreme contrast, although the particular choice of dimension and of the values of D1 and D2 depend of the particular size and configuration of the domelight assembly and housing body being used.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A domelight for an LED device, comprising:
a housing body defining at least one light-emitting surface for transmission of light by an LED, said housing body having at least one contrast surface adjacent the at least one light-emitting surface.

2. The domelight of claim 1, wherein the at least one contrast surface includes a first contrast surface disposed on a first side of the at least one light-emitting surface and a second contrast surface disposed on a second side of the at least one light-emitting surface opposite the first side.

3. The domelight of claim 2, wherein the housing body further defines a plurality of light-emitting surfaces for transmission of light by a plurality of LEDs, the plurality of light-emitting surfaces being arranged substantially parallel to each other and spaced apart by a contrast surface disposed between each of the plurality of light-emitting surfaces.

4. The domelight of claim 1, wherein the at least one contrast surface is substantially dark.

5. The domelight of claim 1, wherein the at least one light-emitting surface has a first width and the at least one contrast surface has a width at least as great as the first width, each width being defined in a direction spanning at least both of the at least one light-emitting surface and the at least one contrast surface.

6. The domelight of claim 1, further comprising at least one LED disposed to emit light through the at least one light-emitting surface.

7. A domelight comprising:
a housing body having at least one LED having a lens body and at least one light-emitting surface on the lens body for transmission of light by the LED, said housing body having at least one contrast surface adjacent the at least one light-emitting surface.

8. The domelight of claim 7, wherein the at least one contrast surface includes a first contrast surface disposed on a first side of the at least one light-emitting surface and a second contrast surface disposed on a second side of the at least one light-emitting surface opposite the first side.

9. The domelight of claim 7, wherein the housing body further includes a plurality of LEDs, each LED having a lens body with a light-emitting surface, the light-emitting surfaces being arranged substantially parallel to each other and spaced apart by a contrast surface disposed between the light-emitting surfaces.

10. The domelight of claim 7, wherein the at least one contrast surface is substantially dark.

11. The domelight of claim 7, wherein the at least one light-emitting surface has a first width and the at least one contrast surface has a width at least as great as the first width, each width being defined in a direction spanning at least both of the at least one light-emitting surface and the at least one contrast surface.

12. A domelight for an LED device, comprising:
an assembly for transmitting light from an LED through at least one light-emitting surface, and
a surface treatment on a portion of the assembly for surrounding the at least one light-emitting surface with a contrast surface.

13. The domelight of claim 12, wherein the at least one contrast surface includes a first contrast surface disposed on a first side of the at least one light-emitting surface and a second contrast surface disposed on a second side of the at least one light-emitting surface opposite the first side.

14. The domelight of claim 12, wherein the assembly includes a plurality of LEDs, each LED having a lens body with a light-emitting surface, the light-emitting surfaces being arranged substantially parallel to each other and spaced apart by a contrast surface disposed between the light-emitting surfaces.

15. The domelight of claim 12, wherein the at least one contrast surface is substantially dark.

16. The domelight of claim 12, wherein the at least one light-emitting surface has a first width and the at least one contrast surface has a width at least as great as the first width, each width being defined in a direction spanning at least both of the at least one light-emitting surface and the at least one contrast surface.

17. A method of displaying light emitted by an LED device, comprising:
emitting light from at least one LED through at least one light-emitting surface; and
disposing a contrast surface adjacent to the at least one light-emitting surface.

18. The method of claim 17, wherein the at least one contrast surface includes a first contrast surface disposed on a first side of the at least one light-emitting surface and a second contrast surface disposed on a second side of the at least one light-emitting surface opposite the first side.

19. The method of claim 17, wherein the at least one LED includes a plurality of LEDs, each LED having a lens body with a light-emitting surface, the light-emitting surfaces being arranged substantially parallel to each other and spaced apart by a contrast surface disposed between the light-emitting surfaces.

20. The method of claim 17, wherein the at least one contrast surface is substantially dark.
